(19) United States
(12) Patent Application Publication
(10) Pub. No.: US 2009/0322232 A1
(43) Pub. Date: Dec. 31, 2009

(54) BRIGHTNESS-AJUSTABLE ILLUMINATION DEVICE AND ILLUMINATION SYSTEM USING THE SAME

(75) Inventor: JUNG-HAU LIN, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: CHI MEI COMMUNICATION SYSTEMS, INC., Tu-Cheng City (TW)

(21) Appl. No.: 12/486,016

(22) Filed: Jun. 17, 2009

(30) Foreign Application Priority Data
Jun. 30, 2008 (CN) 200810302438.X

(51) Int. Cl. H05B 37/02

(52) U.S. Cl. 315/154

(57) ABSTRACT

A brightness-adjustable illumination device includes at least two electric lamps and a control module electronically connected to the at least two electric lamps for controlling the lamps on and off. The control module obtains brightness of local environment of the lamps, and controls the number of the lamps turned on according to the brightness of the local environment. A brightness-adjustable illumination system is also disclosed.

### BACKGROUND

1. Technical Field

The present disclosure generally relates to illumination devices, and particularly, to a brightness-adjustable illumination device and an illumination system using the illumination device.

2. Description of Related Art

Illumination devices such as home lights, street lights, landscape lights, and billboard lights are widely used. The illumination devices are usually fully on or fully off. The illumination devices cannot automatically adjust according to ambient brightness at their location. During times, such as at dusk, it may be only some additional light is needed and therefore it is a waste of power to have all the lights fully on.

Therefore, there is room for improvement within the art.

### BRIEF DESCRIPTION OF THE DRAWINGS

Many aspects of the brightness-adjustable illumination device and illumination system using the same can be better understood with reference to the following drawings. The components in the drawings are not necessarily drawn to scale, the emphasis instead being placed upon clearly illustrating the principles of the brightness-adjustable illumination device and illumination system using the same. Moreover, in the drawings like reference numerals designate corresponding parts throughout the several views.

FIG. 1 is a block diagram of an illumination system in accordance with an exemplary embodiment.

FIG. 2 is a flow chart of the illumination system shown in FIG. 1.

### DETAILED DESCRIPTION OF THE DISCLOSURE

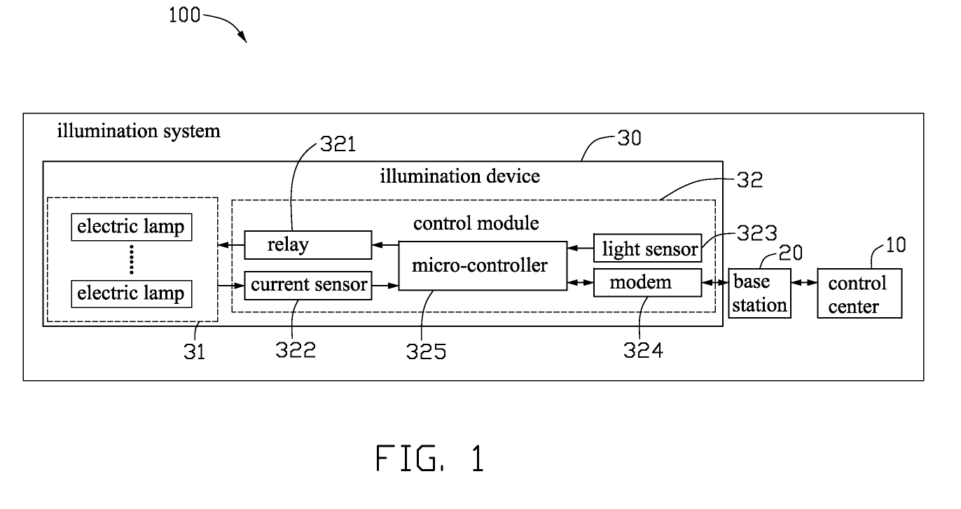

FIG. 1 shows an exemplary illumination system 100 including a control center 10, a base station 20 and a brightness-adjustable illumination device 30. The illumination system 100 can be used in, for example, home, street, landscape, and billboard lighting. The illumination system 100 can determine, after lights of the system 100 have been turned on, if having less lights on will suffice according to predetermined settings of the number of lights that should be on according to different levels of desired brightness. The system 100 will, at the same time, determine if all the lights are working by checking the amount of current drawn by the system after the lights are turned on. The control center 10 is a computer or a single-chip microcomputer configured in a management module of the illumination device 30. The base station 20 is a mobile communication device. The illumination device 30 includes at least two electric lamps 31 and a control module 32 electronically connected to the at least two electric lamps 31.

The control module 32 communicates with the control center 10 through the base station 20 to remotely control the lamps 31 and send the real-time status of the lamps 31 to the control center 10.

The control module 32 is used to control the lamps 31 on and off. The control module 32 obtains the value of electrical current through the lamps 31 and senses the brightness of the local environment. The control module 32 controls the number of lamps 31 turned on according to the brightness of the local environment.

The control module 32 includes a relay 321, a current sensor 322, a light sensor 323, a modem 324 and a micro-controller 325. The relay 321, the current sensor 322, the light sensor 323, and the modem 324 are all electronically connected to the micro-controller 325.

Both the relay 321 and the current sensor 322 are electronically connected to the lamps 31. The current sensor 322 senses the value of electrical current through the lamps 31 to check for faults and transmits the current value to the micro-controller 325. The micro-controller 325 transmits the current value to the control center 10 through the modem 324. The light sensor 323 is used for sensing the brightness of ambient light at the location of the lamps 31, and transmitting the brightness to the micro-controller 325. The modem 324 is used for communicating the micro-controller 325 with the control center 10 through the base station 20. The micro-controller 325 controls the number of the lamps 31 to be turned on according the brightness reading received from the light sensor 323, so that the luminance of the illumination system 100 can be dynamically adjusted according to brightness of ambient light.

The micro-controller 325 receives a control signal from the control center 10 through the modem 324, and transmits the control signal to the relay 321. The relay 321 transmits the control signal to the lamps 31 to selectively control one or more of the lamps 31 to be on.

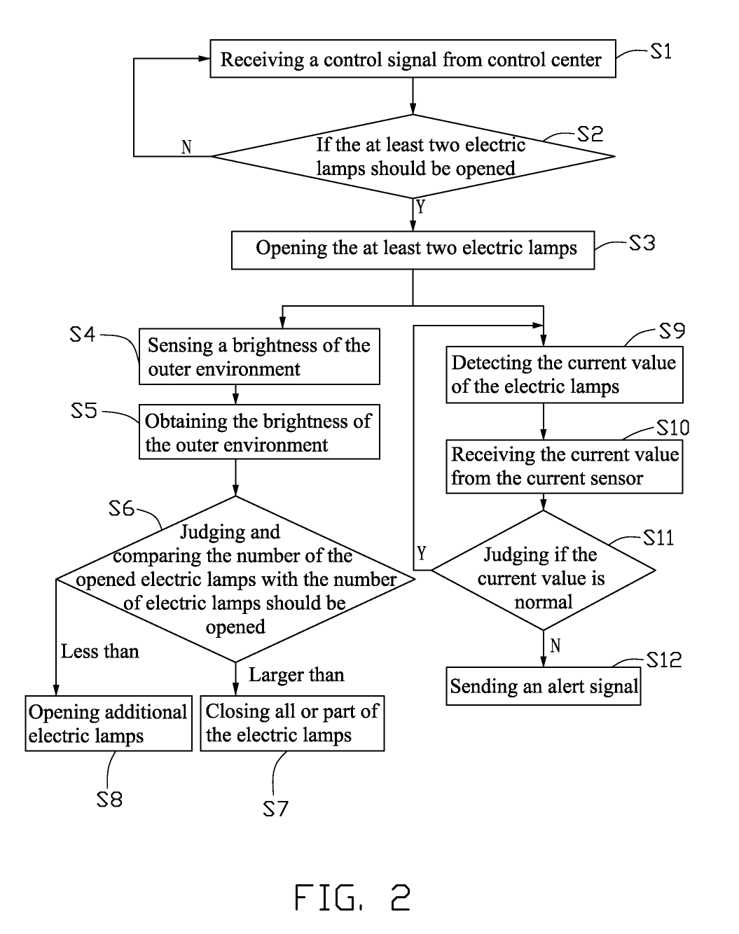

Referring to FIG. 2, a work process of the exemplary illumination system 100 includes the following steps:

In step S1, the modem 324 receives a control signal from the control center 10 through the base station 20, and transmits the control signal to the micro-controller 325.

In step S2, the micro-controller 325 determines if the control signal is an order for turning on the lamps 31. If the control signal is an order for turning on the lamps 31, the process continues by going to step S3; if the control signal is not an order for turning on the lamps 31, the process continues by returning to step S1.

In step S3, the micro-controller 325 controls the relay 321 to turn on the lamps 31, and the process continues by going to steps S4 and S9 simultaneously.

In step S4, once the lamps 31 are turned on, the light sensor 323 senses the brightness of the local environment including light from the lamps 31, and sends the brightness reading to the micro-controller 325.

In step S5, the micro-controller 325 receives the brightness reading from the light sensor 323.

In step S6, the micro-controller 325 decides how many lamps 31 should be on according to the brightness reading.

In step S7, if the number of lamps 31 that should be on is less than the current number of lamp(s) 31 on, then a number of the electric lamp(s) 31 are turned off accordingly.

In step S8, if the number of lamps 31 that should be on is more than the lamp(s) 31 currently on, additional lamps 31 if any available are turned on.

In step S9, the current sensor 322 detects the value of current through the lamps 31, and sends the current value to the micro-controller 325.

In step S10, the micro-controller 325 receives the current value from the current sensor 322.

In step S11, the micro-controller 325 determines if the current value is normal, if yes, the process returns to step S8.

In step S12, if the current value is abnormal, the micro-controller 325 sends an alert signal to the modem 324, and the modem 325 sends the alert signal to the control center 10 through the base station 20, so that the illumination device 30 can be repaired.

Step S4 and S9 should be processed simultaneously, to determine if the lamps 31 are working properly, and to dynamically control the number of lamps 31 turned on.

The illumination device 30 obtains the brightness of the local environment of the system 100, and controls the number of lamps 31 turned on according to the brightness, to avoid wasting power, as well as checking to ensure all lamps are functioning normally by checking current through the lamps.

It should be also understood, however, that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. A brightness-adjustable illumination device, comprising:
at least two electric lamps; and
a control module electronically connected to the lamps for controlling the lamps on and off; the control module sensing the brightness of local environment, and controlling the number of the lamps turned on according to the brightness of the local environment.

2. The illumination device as claimed in claim 1, wherein the control module includes a micro-controller and a light sensor, the light sensor connected to the micro-controller and being used for sensing brightness of the local environment, the light sensor transmitting a brightness reading to the micro-controller.

3. The illumination device as claimed in claim 2, wherein the control module further comprises a relay electronically connected to the micro-controller, the relay being used for receiving control signal from the micro-controller to control the lamps on and off.

4. The illumination device as claimed in claim 2, wherein the control module further comprises a modem being used for receiving an transmitting signal.

5. The illumination device as claimed in claim 2, wherein the control module further comprises a current sensor electronically connected to the micro-controller, the current sensor being used for sensing a value of electrical current of the at lamps and sending the current value to the micro-controller.

6. A brightness-adjustable illumination system, comprising:
a base station;
a control center; and
an illumination device being monitored by the control center through the base station, the illumination device comprising at least two electric lamps and a control module, the control module electronically connected to the at least two electric lamps for controlling the lamps on and off; the control module obtaining brightness of local environment of the lamps, and controlling the number of the lamps turned on according to the brightness of the local environment.

7. The illumination system as claimed in claim 6, wherein the control module includes a micro-controller and a light sensor, the light sensor connected to the micro-controller and being used for sensing brightness of the local environment, the light sensor transmitting the brightness reading to the micro-controller.

8. The illumination system as claimed in claim 7, wherein the control module further comprises a relay electronically connected to the micro-controller, the relay being used for receiving control signal from the micro-controller to control the lamps on and off.

9. The illumination system as claimed in claim 8, wherein the control module further comprises a current sensor electronically connected to the micro-controller, the current sensor being used for sensing a value of electrical current of the lamps and sending the current value to the micro-controller.

10. The illumination system as claimed in claim 9, wherein the control module further comprises a modem being used for transmitting a control signal form the control center to the control module, and sending the current value of the lamps to the control center.
